(19) United States
(12) Patent Application Publication
(10) Pub. No.: US 2002/0133429 A1
(43) Pub. Date: Sep. 19, 2002

(54) Multi-website shopping cart system and the method for the same

(76) Inventor: Hsiang-Chun Lu, Taipei (TW)

Correspondence Address: BIRCH STEWART KOLASCH & BIRCH, PO BOX 747, FALLS CHURCH, VA, 22040-0747, US

(21) Appl. No.: 09/805,206

(22) Filed: Mar. 14, 2001

(51) Int. Cl. G06F 17/60

(52) U.S. Cl. 705/27

(57) ABSTRACT

The invention discloses a multi-website shopping cart implementation method, which uses a main website to provide consumers a hyperlink element linking to an associate website. When a consumer selects the hyperlink element, the main website will transmit the ID of the consumer and the verification code to the associate website so as to verify the identity of the consumer. When the consumer wants to purchase a particular commodity sold at the associate website, the main website will receive trade information transmitted from the associate website and thereby charge to the consumer. Finally, the main website places an order to the associate website and provides the name and the address of the receiver to the associate website. With the trade information, the name and the address of the receiver, the associate website sends out the commodity. The invention also discloses a multi-website shopping cart system to implement the above method.

### BACKGROUND OF THE INVENTION

1. Field of Invention

The invention relates to a multi-website shopping cart system and the implementation method and, in particular, to the multi-website shopping cart system and method that allows consumers to purchase commodities from a main website by sending a verification code to an associate website.

2. Related Art

With the development in network technologies, using networks to conduct various commercial activities has become a new type of business. After a company sets up a website, consumers can log-on to the website through a network to browse the website content and select desired commodities or services.

Taking the Internet as an example, if a company wants to use the Internet to conduct business activities, a WWW website in the hypertext transmission protocol (HTTP) format can be set up in a server. A consumer can browse the website content using any web browser from a personal computer (PC). When the consumer is interested in a particular commodity or service provided on the website, he can directly order it on the Internet. The company can use various kinds or trade mechanisms, such as credit card or electronic wallet payment, to bill the consumer.

However, due to the following drawbacks existing in the above trade mechanisms, consumers are often less willing to purchase on the networks.

First, web trade is always insecure. When a consumer wants purchase some commodity or service on a network, he has to enter a lot of personal data, such as his name, address, and credit card number, and transmit these personal data to the company's website for trade. Nevertheless, data transmission on the network goes through many nodes, where hackers can intercept the data at any node, causing the release of personal data.

Furthermore, consumers have to register the basic data at different website databases when shipping at different websites, which is very inconvenient. As more and more commodity or service providers start to use the network to do their businesses, it is less likely that a consumer will stay with the same website and purchase all commodities he needs. Therefore, if the consumer has to enter his personal data every time he logs onto a new website, he may not be willing to purchase on the network.

### SUMMARY OF THE INVENTION

Pursuant to the above problems, it is an objective of the invention to provide a multi-website shopping cart system and the method to implement it. The invention can effectively increase the consumer's will to purchase via a network.

It is another objective of the invention to provide a multi-website shopping cart system and the implementation method that can increase network trading security.

It is yet another objective of the invention to provide a multi-website shopping cart system and the implementation method so that consumers do not have to enter their basic data as often when shopping online.

To achieve the above objectives, the disclosed method uses a main website to provide consumers a hyperlink element linking to an associate website. When a consumer selects this hyperlink element, the main website will transmit the consumer's ID and verification code to the associate website to verify the consumer's identity. When the consumer purchases a commodity sold at the associate website, the main website receives trade information transmitted from the associate website and thereby bills to the consumer. Finally, the main website places an order and provides a receiver's name and the address of the recipient to the associate website. The associate website then sends out the commodity according to the trade information and the name of the recipient and the address of the recipient provided by the main website.

Since in the disclosed method consumers are able to purchase in the associate website without the need to register basic data, they will be more willing to log-on and purchase at the associate website through a network.

In the disclosed method the main website and the associate websites only interchange data such as consumer's IDs, verification codes, and the names and addresses of the receivers, other basic data such as consumer's credit card numbers, E-mail accounts, etc are not transmitted over the network. Therefore, the method can effectively reduce the risk the data of consumer being released and intercepted. That is, the disclosed method has a higher network trading security.

### BRIEF DESCRIPTION OF THE DRAWINGS

The invention will become more fully understood from the detailed description given hereinbelow illustration only, and thus are not limitative of the invention, and wherein:

FIG. 1 is a flowchart showing the procedure of the implementation method of a multi-website shopping cart according to a preferred embodiment of the invention;

FIG. 2 is a schematic view showing the structure of a multi-website shopping cart system according to a preferred embodiment of the invention; and

FIG. 3 is a schematic view showing exemplary applications of a multi-website shopping cart system according to a preferred embodiment of the invention.

### DETAILED DESCRIPTION OF THE INVENTION

The t invention of a multi-website shopping cart method will be apparent from the following detailed description, which proceeds with reference to the accompanying drawings, wherein the same references relate to the same elements.

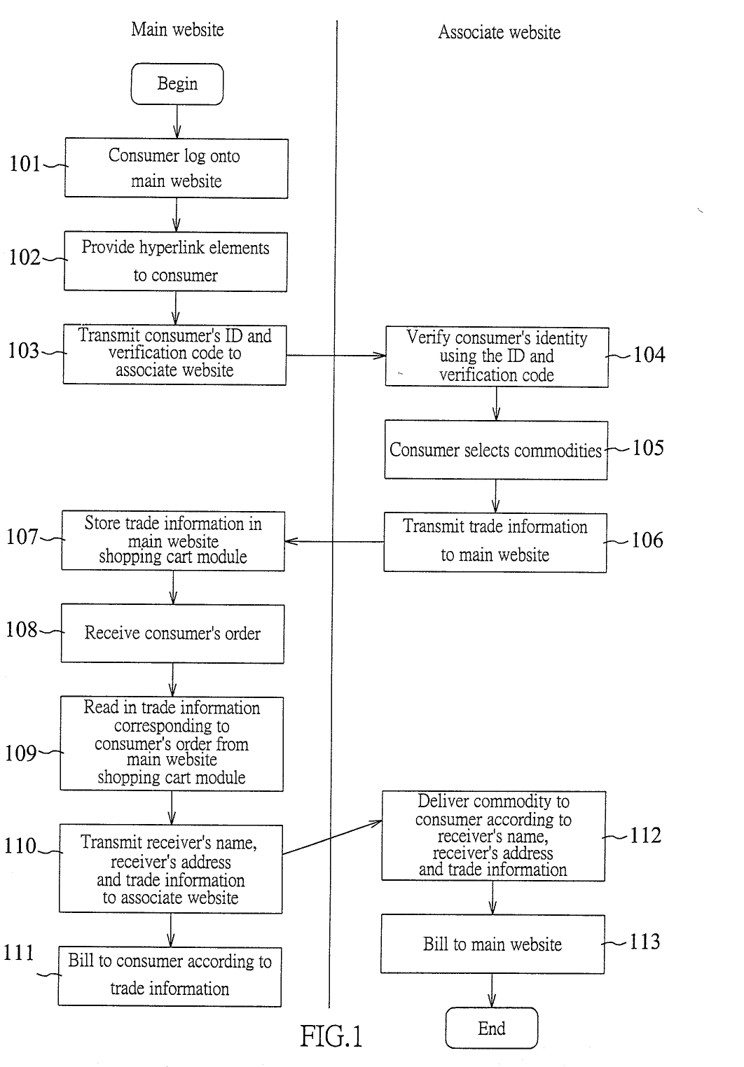

With reference to FIG. 1, a preferred embodiment of the disclosed method 1 first allows a consumer to log-on to a main website in step 101. Before successfully logging onto the main website, the consumer has to register his basic data in the main website. Such basic data include, but are not limited to, an ID, a password, a name, an address and a credit card number. After registering his basic data, the consumer can verify his identity by simply providing the ID and the password while logging in. Of course, if he does not register his basic data, the consumer can still browse the web page content in the main website and enjoy some free services. However, only after registering his basic data can the consumer perform various kinds of trades on the main website, e.g., purchasing a commodity.

In step 102, the main website provides the consumer a hyperlink element linked to an associate website. After the consumer selects this hyperlink element, he can link to the associate website. The hyperlink element provided to the consumer by the main website can be a text or graphic hyperlink. For example, the main website can provide a banner to the consumer. After the consumer clicks on this banner, he is linked to the corresponding associate website.

When the consumer selects a hyperlink element, the main website will transmit the ID of the consumer and the verification code to the associate website in step 103 for the associate website to verify the c identity of the consume. Here the ID of the consumer refers to the ID of the consumer registered in the main website or an ID assigned to the consumer by the main website. The verification code refers to an encrypted code generated by the main website according to the basic data of the consumer following some algorithm. Its purpose is to verify the identity of the consumer and whether the consumer is hyperlinked from the main website. How to verify the identity of the consumer will be explicitly explained hereinafter.

After the associate website receives the ID of the consumer and the verification code transmitted from the main website, step 104 proceeds to verify the identity of the consumer accordingly. The verifying method can vary according to different situations. For example, the main website can provide the associate website a checking mechanism to check the verification code. Thus, when the ID and verification code transmitted from the main website are received, the checking mechanism can be directly employed to perform checks and to verify the identity of the consumer. The checking method performed by the checking mechanism on the verification code can vary according to different methods of forming the verification code. For example, if the verification code is obtained by performing bit operations on each character in the ID of the consumer that shifts each bit to the right by two positions to obtain a new character, then the checking mechanism then performs an inverse operation on the verification code to shift each bit to the left by two positions and compares if the inversed result is the same as the ID of the consumer. If they agree, then the consumer is indeed a consumer hyperlinked from the main website.

In step 105, the associate website allows the consumer to select a particular commodity. In the current embodiment, the associate website provides commodity related information, such as its appearance, a description, price, etc, in a hypertext markup language (HTML) file to the consumer so that the consumer can browse through all commodities sold at the associate website and thereby determine whether he wants to select anything. If the consumer decides to purchase a particular commodity, he can click on it to indicate the needed item and quantity.

In step 106, the associate website will provide trade information related to this trading action to the main website. The so-called trade information includes the commodity name, price, quantity, the consumer ID of the person who performs this trading action, and the associate website code.

After receiving the trade information transmitted from the associate website, the main website stores the received trade information in a main website shopping cart module. The main website shopping cart module is similar to the ones used in typical on-line stores in the prior art. That is, when the consumer selects a particular commodity, the shopping cart module will first store information related to the selected commodity, such as name, code, and quantity, without sending the commodity and billing to the consumer immediately. At the same time, the shopping cart module provides the consumer a commodity trade management interface so that he can browse the commodities selected to determine whether he wants to continue the trade on a particular item or to delete an item. When the consumer decides to purchase a particular commodity, he can precede with the trade through the commodity trade management interface provided by the shopping cart module.

The difference of the main website shopping cart module disclosed in the current embodiment from the conventional ones is that the main website shopping cart module stores the information about where each piece of trade information is transmitted from. In other words, there are not only the commodity related information and the consumer ID but also the associate website ID in the trade information. Therefore, the consumer does not only browse the selected commodity data but also data about in which website each commodity is selected.

Afterwards, in step 108, the main website receives an order sent from the consumer. The order refers to the purchase request made by the consumer on a particular item stored in the main website shopping cart module. For example, if the consumer has selected a commodity in an associate website and stores the related trade information in the main website shopping cart module, then he can select this item in step 108 and send out a request to the main website to deliver this item and bill him.

Once the order of the consumer is received, the main website proceeds to step 109 to read from the main website shopping cart module the trade information corresponding to the order. Afterwards, the main website transmits the name of the receiver and the address of the receiver registered by the consumer along with the trade information to the associate website in step 110 so as to place an order at the associate website.

It should be noted that the name of the receiver is not necessarily the name of the consumer and the address of the receiver may not be the address of the consumer. For example, if the commodity is a birthday gift for a friend, the consumer can assign the commodity to be sent to his friend's place with his friend as the receiver. The consumer can also assign the commodity to be sent to a particular convenience store so that the consumer can pick it up after work.

The main website starts to bill to the consumer according to the trade information in step 111. For example, if the consumer uses a credit card to pay the bill, the main website will read in the credit card number from the basic data registered by the consumer and utilizes a credit card payment mechanism to ask for money from the credit card bank according to the commodity name, quantity and price recorded in the trade information.

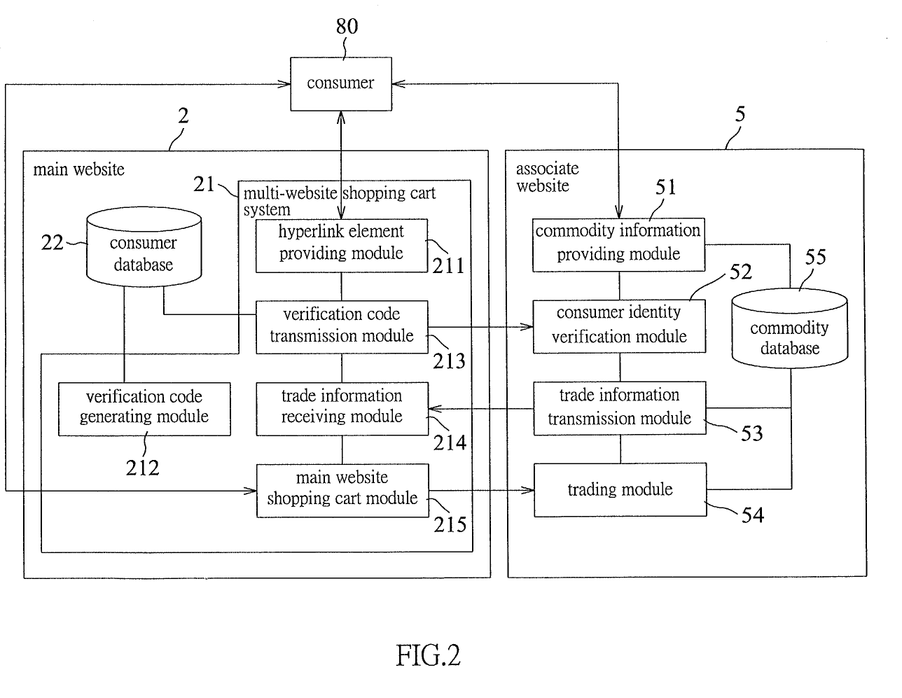

With reference to FIG. 2, the multi-website shopping cart system 21 according to a preferred embodiment of the invention is implemented in a main website 2. In addition to the multi-website shopping cart system 21, the main website 2 further has a consumer database 22 storing at least one set of basic data registered by the consumer 80. The basic data include but are not limited to a consumer ID, a password, a receiver name, and a receiver address. FIR. 2 further shows an associate website 5 associated with the main website 2. The associate website 5 includes a commodity information providing module 51, a consumer identity verification module 52, a trade information transmission module 53, a trading module 54, and a commodity database 55. The function of each of the above modules will be further explained hereinafter.

The multi-website shopping cart system 21 includes a hyperlink element providing module 211, a verification code generating module 212, a verification code transmission module 213, a trade information receiving module 214, and a main website shopping cart module 215. The hyperlink element providing module 211 provides at least one hyperlink element to the consumer 80. As described herein before, when the consumer 80 selects the hyperlink element, he will be linked to the associate website 5 and can browse the commodity contents in the commodity database 55 through the commodity information providing module 51.

When the consumer 80 hyperlinks from the main website 2 to the associate website 5, the verification code transmission module 213 transmits the verification code of the consumer to the consumer identity verification module 52 of the associate website 5 for the associate website 5 to verify the identity of the consumer and see if he is linked from the main website. Once verified, if the consumer 80 selects a particular commodity, the associate website 5 transmits related trade information to the trade information receiving module 214 through the trade information transmission module 53. The generation of the verification code is done by the verification code generating module 212 using any coding method, such as bit operations, according to the data in the consumer database 22. Therefore, the consumer identity verification module 52 can verify the identity of the consumer through a decoding procedure.

Once verified, if the consumer 80 selects some commodity sold at the associate website 5, the trade information transmission module 53 will transmit the trade information to the trade information receiving module 214 of the main website 2. The trade information transmission module 53 and the trade information receiving module 214 can communicate through any transmission network, such as the Internet, a wireless network, or a local area network (LAN). The hardware and software equipment also varies according to the type of the transmission network. For example, the TCP/IP protocol can be used to transmit signals on a package exchange network. Or, the WAP protocol can be used for signal transmission on a wireless network.

The main website shopping cart module 215 stores the trade information received by the trade information receiving module 214 and provides a commodity management interface to the consumer 80 for him to browse and manage selected commodities in the associate website. When the consumer 80 transmits an order, the main website shopping cart module 215 sends the stored trade information along with the name of the receiver and the address of the receiver to the trading module 54 of the associate website 5. The associate website 5 then delivers the commodities according to the trade information, the name of the receiver and the address of the receiver.

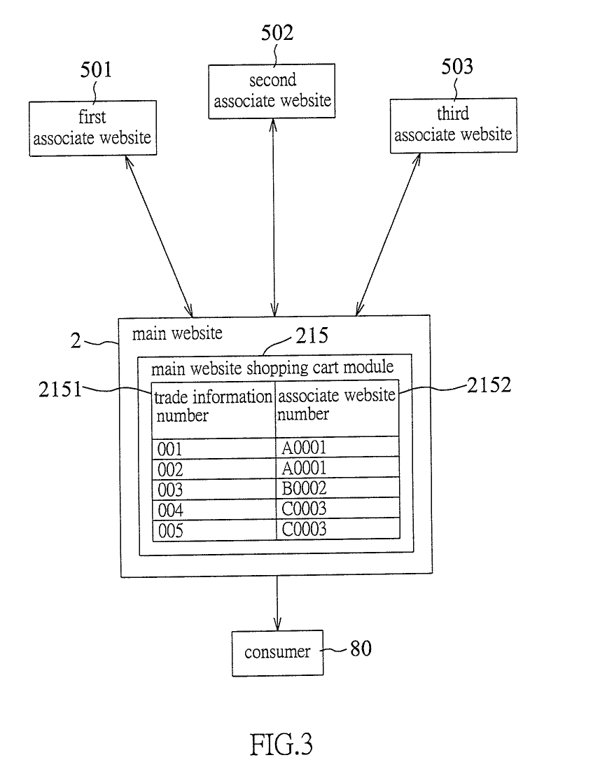

Through the above-mentioned multi-website shopping cart system 21, the main website 2 can provide the service of connecting the consumer 80 to a plurality of associate websites. With reference to FIG. 3, by clicking on the hyperlink elements in the main website 2, the consumer 80 can link to three different associate websites, namely a first associate website 501, a second associate website 502, and a third associate website 503. For example, suppose he selects two commodities in the first associate website 501, one commodity in the second associate website 502, and two commodities in the third associate website 503, then the main website shopping cart module 215 of the main website 2 will store five items in the trade information, represented by different trade information numbers 2151, and the source associate website of each item, represented by different associate website numbers 2152. The consumer 80 can use the main website shopping cart module 215 to trade or delete any particular item without going back to each associate website.

According to the above-mentioned multi-website shopping cart system and its implementation method, the consumer can go shopping without the need to register his basic data over and over again at each associate website. Therefore, the system and method can effectively increase the desire of the consumer to purchase via a network.

In the disclosed method, the main website and the associate websites only interchange data such as consumer IDs, verification codes, and the names of the recievers and addresses, other basic data such as consumer's credit card numbers, E-mail accounts, etc are not transmitted over the network. Therefore, the method can effectively reduce the risk of consumer's data being released and intercepted. That is, the disclosed method has a higher network trading security.

Certain variations would be apparent to those skilled in the art, which variations are considered within the spirit and scope of the claimed invention.

What is claimed is:

1. A method for implementing a multi-website shopping cart carried out on a main website which stores the name of the receiver and the address of the receiver registered by a consumer, the method comprising the steps of:
providing the consumer a hyperlink element linking to an associate website;
transmitting the ID of the consumer and the verification code the associate website to verify his identity when the consumer selects the hyperlink element;
receiving trade information transmitted from the associate website when the consumer selects one commodity sold at the associate website;
storing the trade information in a main website shopping cart module;
receiving an order sent from the consumer;
reading in the trade information corresponding to the order and billing to the consumer; and
placing an order to the associate website for the associate website to deliver the commodity according to the trade information, the name of the receiver, and the address of the receiver.

2. The method of claim 1, wherein when the consumer selects one commodity sold at the associate website, the trade information is first recorded in a united web shopping cart module of the associate website and then transmitted to the main website.

3. The method of claim 1 further comprising the step of accepting the billing action performed by the associate website according to the trade information.

4. The method of claim 1 further comprising the step of providing the associate website a verification mechanism for the associate website to verify the identity of the consumer before the ID and the verification code are sent to the associate website.

5. The method of claim 1, wherein the trade information contains the ID, the verification code, the commodity data, and the commodity quantity needed.

6. A method for implementing a multi-website shopping cart carried out in an associate website, the method comprising the steps of:
receiving the Id of the consumer and the verification code transmitted from a main website;
verifying the identity of the consumer according to the ID and the verification code to verify that the consumer is linked from the main website through a hyperlink;
transmitting trade information to the main website, which stores the trade information in a main website shopping cart module, when the consumer selects one commodity sold at the associate website;
when the consumer sends an order to the main website, receiving the trade information corresponding to the order, the name of the receiver, the address of the receiver transmitted from the main website, the trade information corresponding to the order being read in from the main website shopping cart module; and
delivering the commodity to the consumer according to the trade information, the name of the receiver, and the address of the receiver.

7. The method of claim 6, wherein the trade information is first stored in a united web shopping cart module at the associate website and then transmitted to the main website when the consumer selects one commodity sold at the associate website.

8. The method of claim 6 further comprising the step of accepting the billing action performed by the associate website according to the trade information.

9. The method of claim 6 further comprising the step of receiving a verification mechanism provided by the main website to verify the consumer's identity.

10. The method of claim 6, wherein the trade information contains the ID, the verification code, the commodity data, and the commodity quantity needed.

11. A multi-website shopping cart system implemented in a main website which stores the name and address of the receiver registered by a consumer, wherein the system comprises:
a hyperlink element providing module, which provides the consumer a hyperlink element linking to an associate website;
a verification code transmission module, which transmits the verification code of the consumer to the associate website to verify the identity of the consumer when the consumer selects the hyperlink element;
a trade information receiving module, which receives trade information transmitted from the associate website when the consumer selects a commodity sold at the associate website, the trade information containing the identification data of the associate website; and
a main website shopping cart module, which stores the trade information for the consumer to browse and, according to an order requested by the consumer, sends out the trade information, the name of the receiver, and the address of the receiver to the associate website whereby the associate website delivers the commodity.

12. The system of claim 11 further comprising a verification code generating module which generates the verification code of the consumer.

13. The system of claim 11 further comprising a consumer database which stores the verification code, the name, and the address of the receiver.

14. The system of claim 11, wherein the trade information contains the ID, the verification code, the commodity data, and the commodity quantity needed.
